(19) United States
(12) Patent Application Publication
(10) Pub. No.: US 2003/0118135 A1
(43) Pub. Date: Jun. 26, 2003

(54) Clock distribution device for multiband modem

(76) Inventors: Hoon Lee, Daejon (KR); Je-Soo Ko, Daejon (KR); Tae-Whan Yoo, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/191,018

(22) Filed: Jul. 8, 2002

(30) Foreign Application Priority Data
Dec. 20, 2001 (KR) 2001-82099

(51) Int. Cl. H04L 7/00

(52) U.S. Cl. 375/354

(57) ABSTRACT

A clock distribution device for a multiband modem which is capable of recovering a clock from a received signal of a highest-performance one of multiple bands and applying the recovered clock for clocks of the other bands. The clock distribution device recovers a clock from a received signal and distributes the recovered clock to multiple bands. That is, the clock distribution device is adapted to recover a symbol clock or sampling clock of a certain band from a received multiband signal, generate a high-frequency clock on the basis of the recovered clock, generate a highest-frequency clock among clocks necessary to each of the multiple bands on the basis of the generated high-frequency clock, and generate and distribute all the clocks necessary to each of the multiple bands on the basis of the generated highest-frequency clock.

### BACKGROUND OF THE INVENTION

1. Field of the Invention

The present invention relates to a device for distributing clocks to a modem supporting multiple bands, and more particularly to a clock distribution device for a multiband modem which is capable of recovering a clock from a received signal of a highest-performance one of multiple bands and applying the recovered clock for clocks of the other bands.

2. Description of the Related Art

At the present, important factors in general clock distribution circuits and devices may be roughly classified into three types: generating independent clocks with various frequencies from one clock source; making skews of the generated various clocks equal; and using low-frequency clocks for implementation of low-power circuits as far as possible.

The clock skew is generated when an associated clock distribution device has different clock delays. That is, the clock skew is generated due to a propagation delay, a buffer delay in the distribution device, a resistance-capacitance (RC) delay on a clock distribution line, etc.

Problems to overcome in clock distributing of a general modem are to recover a clock from a signal that is received by a receiver over a transmission line, and to reduce the skew between clocks in procedures of generating and distributing a variety of clocks necessary to a given band from the recovered clock. The generation of clocks with various frequencies from a given clock source is closely connected with the implementation of a low-power circuit.

In the general modem, a symbol clock or sampling clock is recovered from a received signal and then used as a system clock. At this time, the recovered clock is usually multiplied or divided for generation of a high-frequency clock necessary to circuit design.

In a conventional multiband modem, however, a plurality of transceivers which employ different symbol rates and different parameters are provided, so a separate clock recovery circuit must be provided in each band receiver and a signal analog/digital-converted and inputted to each band receiver must be sampled again. This makes circuit implementation difficult and increases the amount of hardware.

On the other hand, various devices and methods for distributing clocks in systems have been introduced. One such example is a clock signal distribution device disclosed in Korean Patent Application No. 1998-21164, which reduces skews of clock signals inputted respectively to a plurality of units which are operated in response to the clock signals. The clock signal distribution device comprises global drive means for receiving an input clock signal and driving it as a global clock signal, and a plurality of output buffering means for receiving the global clock signal from the global drive means and distributing it to the plurality of units, respectively. Namely, the clock signal distribution device generates a global clock signal by distributing an external input clock signal for removing skews between the signals of the distributed clocks inputted respectively to the units and provides the generated global clock signal to the units, respectively. However, this device is adapted to merely minimize skews by distributing clocks at the same line lengths.

Another example is a clock distribution circuit in an integrated circuit disclosed in U.S. Pat. No. 6,252,449. This clock distribution circuit is adapted to merely distribute low-power clocks. That is, the integrated circuit is partitioned into individual blocks according to independent clocks, and a main clock with low-frequency is distributed to each of the partitioned blocks. Each of the blocks multiplies or divides the main low-frequency clock to generate low-frequency clocks to be actually used, thereby enabling a low-power circuit to be readily implemented.

As a result, the above clock distribution device and circuit cannot basically solve the above-mentioned problems.

### SUMMARY OF THE INVENTION

Therefore, the present invention has been made in view of the above problems, and it is an object of the present invention to provide a clock distribution device for a multiband modem which is capable of recovering a clock from a received signal of a highest-performance one of multiple bands and applying the recovered clock for clocks of the other bands, so that it is simple in construction, programmable and high in performance.

In accordance with the present invention, the above and other objects can be accomplished by the provision of a clock distribution device for a multiband modem which recovers a clock from a received signal and distributes the recovered clock to multiple bands, the clock distribution device being configured to recover a symbol clock or sampling clock of a certain band from a received multiband signal, generate a high-frequency clock on the basis of the recovered clock, generate a highest-frequency clock necessary to each of bands on the basis of the generated high-frequency clock, and generate and distribute all the clocks necessary to each of said bands on the basis of the generated highest-frequency clock.

Preferably, the clock distribution device may comprise: a signal converter for converting said received multiband analog signal into a digital signal; a pre-circuit for extracting each band signal from said converted digital signal; a clock recovery circuit for recovering said symbol clock or sampling clock from a highest-performance one among each of said band signals extracted by said pre-circuit; a clock synthesizer for generating said high-frequency clock on the basis of said recovered clock; a plurality of oscillators, each for generating said highest-frequency clock among clocks necessary to said each band on the basis of said high-frequency clock generated by said clock synthesizer; and a plurality of band clock generators, each for generating and distributing a plurality of clocks necessary to said each band on the basis of said generated highest-frequency clock.

### BRIEF DESCRIPTION OF THE DRAWINGS

The above and other objects, features and other advantages of the present invention will be more clearly understood from the following detailed description taken in conjunction with the accompanying drawing:

FIG. 1 is a block diagram showing the construction of a clock distribution device for a multiband modem in accordance with a preferred embodiment of the present invention.

### DESCRIPTION OF THE PREFERRED EMBODIMENTS

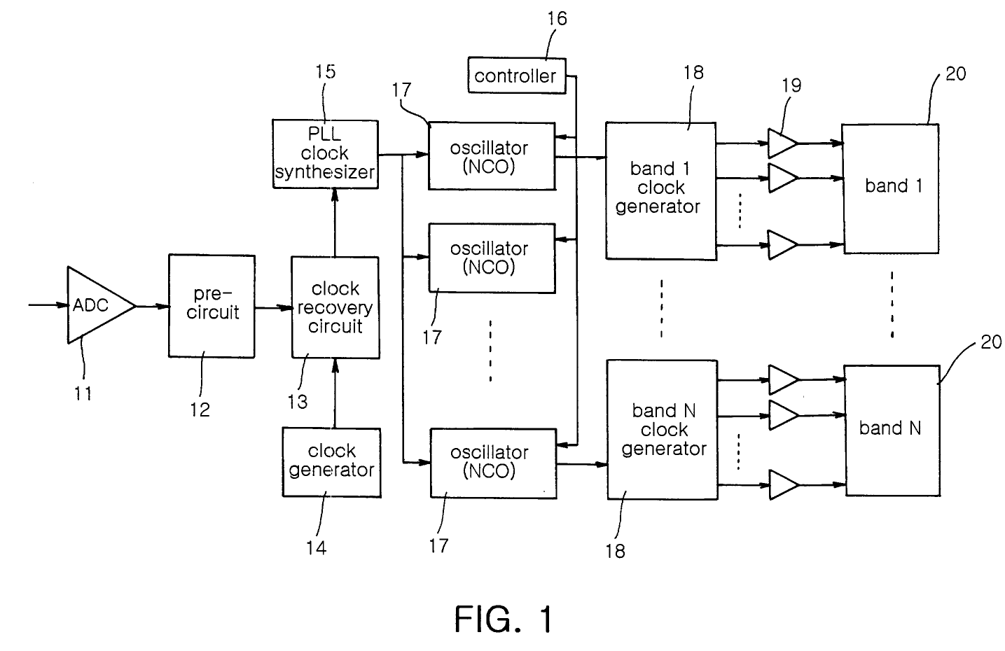

With reference to FIG. 1, there is shown in block form the construction of a clock distribution device for a multiband modem in accordance with a preferred embodiment of the present invention. As shown in this drawing, the multiband modem has N independent bands, each of which operates as one transmitter or receiver. Because the multiband modem employs a frequency division duplexing system, all the independent bands occupy one frequency band at a frequency domain.

In particular, FIG. 1 shows a procedure of recovering a receiver clock of the multiband modem and distributing clocks on the basis of the recovered receiver clock. A multiband modem signal passed through a channel, not shown, is converted into a digital signal by an analog/digital converter (ADC) 11. In terms of the frequency domain, the signal received through the channel is the sum of bandwidth-limited signals divided into N frequency bands. Because it is very hard to recover a clock from the signal received through the channel and the clock recovery performance is also significantly degraded, the converted signal by analog/digital converter (ADC) is divided into independent band signal respectively by a pre-circuit 12, and the divided signals from the pre-circuit 12 are transferred to a clock recovery circuit 13 so that the clock recovery circuit 13 can easily perform the clock recovery on the basis of the transferred band signals. The clock recovery circuit 13 recovers a clock using a highest-performance one of the N band signals from the pre-circuit 12 in response to a reference clock from a clock generator 14. Preferably, a lowest-frequency band signal among the N band signals is appropriate for the clock recovery because it is least influenced by the channel. The clock recovery circuit 13 recovers a symbol clock or sampling clock synchronized with data of a received signal and inputs the recovered clock to a phase locked loop (PLL) clock synthesizer 15.

The low-frequency symbol clock or sampling clock recovered by the clock recovery circuit 13 is regenerated as a high-frequency clock through the clock synthesizer 15. Then, a plurality of programmable digital oscillators 17 each receive the regenerated high-frequency clock from the clock synthesizer 15 and regenerate a highest-frequency clock among clocks desired by each band 20. Each of the oscillators 17 is preferably a numerically controlled oscillator (NCO), which outputs the highest-frequency clock among the clocks desired by each band 20 under control of a controller 16. The oscillators 17 are preferably the same in number as the bands 20. Alternatively, a larger number of oscillators 17 may be provided to supply clocks desired by other devices.

On the other hand, each of the clocks used in each band 20 generally has a frequency which is ½^{N} time (N is a natural number) that of the highest-frequency clock. Each of the oscillators 17 provides the highest-frequency clock among the clocks desired by each band 20, and a plurality of band clock generators 18 each divide the provided highest-frequency clock into the clocks desired by each band 20. Each of the band clock generators 18 preferably includes the same number of D flip-flops as that of the independent clocks desired by each band 20.

In the clock distribution device according to the present invention, the length of a clock path having a high frequency can be minimized by disposing the PLL and each oscillator NCO closer to each other, as far as possible. Furthermore, the skews between clocks can be minimized by equalizing the length of a clock line from a PLL output clock to each oscillator NCO and the length of a clock line from each oscillator NCO to each clock buffer 19.

As described above, the clock distribution device according to the present invention receives one input clock from an external crystal oscillator or an internal clock source and distributes the received input clock to each band desiring various clocks. The clock source is used as a low-frequency clock, and a PLL clock synthesizer is disposed adjacent to each band desiring various clocks, to provide multiplied versions of the clock source directly to each function block, thereby reducing power consumption and minimizing effects caused from crosstalk and noise on clock lines. Further, a programmable frequency clock can be provided by disposing the PLL adjacent to each block. Furthermore, a purer clock can be provided by minimizing its distance to each function block.

As apparent from the above description, the present invention provides a clock distribution device for a multiband modem which is capable of effectively providing clocks necessary to a plurality of independent bands on the basis of a clock recovered by one clock recovery circuit.

Moreover, according to the present invention, the clock distribution device can easily change a clock rate of each band and be implemented with a small amount of hardware.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A clock distribution device for a multiband modem which recovers a clock from a received signal and distributes the recovered clock to multiple bands, said clock distribution device being configured to recover a symbol clock or sampling clock of a certain band from a received multiband signal, generate a high-frequency clock on the basis of the recovered clock, generate a highest-frequency clock necessary to each of bands on the basis of the generated high-frequency clock, and generate and distribute all the clocks necessary to each of said bands on the basis of the generated highest-frequency clock.

2. The clock distribution device according to claim 1, wherein said clock distribution device comprises:
a signal converter for converting analog signal of said received multiband into a digital signal;
a pre-circuit for extracting each band signal from said converted digital signal;
a clock recovery circuit for recovering said symbol clock or sampling clock from a highest-performance one among each of said band signals extracted by said pre-circuit;
a clock synthesizer for generating a high-frequency clock on the basis of said recovered clock;
a plurality of oscillators, each for generating the highest-frequency clock among clocks necessary to said each band on the basis of said high-frequency clock generated by said clock synthesizer; and
a plurality of band clock generators, each for generating and distributing a plurality of clocks necessary to said each band on the basis of said generated highest-frequency clock.

3. The clock distribution device according to claim 2, further comprising a selected one of an external crystal oscillator or an internal clock source for inputting one low-frequency clock to said clock recovery circuit.

4. The clock distribution device according to claim 1 wherein a clock rate according to the each band is adjusted by distributing the generated high-frequency clock to the corresponding each band using a programmable NCO (Numerically Controlled Oscillator).

5. The clock distribution device according to claim 1, wherein said symbol clock or sampling clock is recovered on the basis of a band signal in lowest-frequency band.

6. The clock distribution device according to claim 2, wherein the plurality of clocks necessary to one band of said multiband modem in said band clock generator are clocks with frequency of ½ times as contrasted with said inputted highest-frequency clock.

7. The clock distribution device according to claim 2 wherein a clock rate according to the each band is adjusted by distributing the generated high-frequency clock to the corresponding each band using a programmable NCO(Numerically Controlled Oscillator).
